(19) United States
(12) Patent Application Publication
(10) Pub. No.: US 2006/0277425 A1
(43) Pub. Date: Dec. 7, 2006

(54) System and method for power saving in pipelined microprocessors

(76) Inventors: Erik K. Renno, Trondheim (NO); Oyvind Strom, Trondheim (NO)

Correspondence Address: SCHNECK & SCHNECK, P.O. BOX 2-E, SAN JOSE, CA, 95109-0005, US

(21) Appl. No.: 11/146,467

(22) Filed: Jun. 7, 2005

(51) Int. Cl. G06F 1/00

(52) U.S. Cl. 713/323; 712/218

(57) ABSTRACT

A system and method for preserving power in a microprocessor pipeline. The system includes a register file read control unit, the read control unit being configured to monitor one or more outputs from a control/decode unit of the pipeline and monitor write addresses from one or more other stages of the pipeline. The system also includes one or more read inhibit units each having an input, an output, and an enable terminal, the output of each of the one or more read inhibit units being coupled to a unique register port of a register file within the pipeline. The input of each of the one or more read inhibit units being coupled to the control/decode unit, and the enable terminal of each of the one or more read inhibit units being coupled to a unique output of the read control unit.

### TECHNICAL FIELD

The invention relates generally to a reduction of power consumption in microprocessors, both load-store architectures (i.e., RISC-based machines) and memory-oriented architectures (i.e., CISC-based machines). More specifically, the invention provides a technique and method for avoiding unnecessary read operations from a register file thereby resulting in a lower power dissipation from the microprocessor.

### BACKGROUND ART

Many modern computing systems utilize a processor having a pipelined architecture to increase instruction throughput. In theory, pipelined processors can execute one instruction per machine cycle when a well-ordered sequential instruction stream is being executed. Pipelined processors operate by breaking up the execution of an instruction into several stages, each stage requiring one machine cycle to complete. In a typical system, an instruction could require many machine cycles to complete (e.g., fetch, decode, ALU operations, etc.). However, latency is reduced in pipelined processors by initiating the processing of a second instruction before the actual execution of the first instruction is completed. Consequently, multiple instructions can be in various stages of processing at any given time. Thus, the overall instruction execution latency of the system (which may be considered as a delay between the time a sequence of instructions is initiated and the time the execution of the instructions is completed) can be significantly reduced.

Most modern microprocessors are using pipelined datapaths to allow for higher clock frequencies and prevent or reduce the number of pipeline stalls. As stated supra, a principle behind pipelining is to divide an instruction into several smaller operations and execute each operation in subsequent clock cycles on hardware dedicated to the substrate-operations. Such a system may be modeled as a linear pipeline where instructions flow through hardware units. A typical pipeline implements the following operations; each operation being performed by dedicated hardware:
1. instruction fetch;
2. instruction decode and generation of control signals to later pipeline stages;
3. read operands from register file;
4. instruction execute (results from arithmetical operations such as “add” may be produced here);
5. memory read (data read from memory is available here); and
6. result writeback to register file.
   Each of these operations is performed by hardware, and all flow of signals between stages is passed through clocked registers.

FIG. 1 illustrates a typical prior art pipeline capable of performing the operations described supra. FIG. 1 is stylized, leaving out details of a complete datapath as such pipelined microprocessor sections are well-known to one of skill in the art. FIG. 1 includes a program counter (PC) 101, an instruction memory (IM) 103, a register file 109, an arithmetic logic unit (ALU) 113, and a multiplexer 119. Sections of the prior art pipeline include an instruction fetch stage 105, an instruction decode and register file read stage 107, an execute stage 111, a memory access stage 115, and a writeback stage 117. Since all pipeline stages (105, 107, 111, 115, and 117) are separated by one of the plurality of clocked registers, six different instructions can be in the pipeline at the same time. If, for example, an instruction in the execute stage 111 wants to read a value in a register written by an instruction in the memory access stage 115, or the writeback stage 117, the execute stage 111 must wait until the value has been written into the register file 109, otherwise an erroneous (i.e., previously written) value will be read.

Furthermore, in a pipeline, results may be ready long before an instruction has reached the writeback stage 117 of the pipeline. One way to increase an executional speed through the pipeline is through incorporation of a forwarding technique. A forwarding pipeline 200 of FIG. 2 incorporates the forwarding technique and includes an ID forward control unit (ID fwd ctrl) 201A and an EX forward control unit (EX fwd ctrl) 201B and two forwarding multiplexers 203 within the instruction decode and register file read stage 107 and execute stage 111. Executional speed is increased in the forwarding pipeline 200 by avoiding an inaccessibility of intermediate results. For example, results of an arithmetical operation may be ready in the execute stage 111. Results that are ready in the execute stage 111, memory access stage 115, or writeback stage 117 and that are needed by an instruction in an earlier (i.e., upstream) stage may forward the results directly to the earlier stage in need of the data. Therefore, an instruction in the instruction decode stage 107 does not need to stall until the result is written back to the register file 109.

The ID forward control unit 201A forwards data written into the register file 109 by the writeback stage 117 to outputs of the register file 109 if the register read from the register file 109 is the same register that is being written by the writeback stage 117. The EX forward control unit 201B listens to readrega and readregb from the instruction decode and register file read stage 107 pipeline registers and write_addr from the memory access stage 115 or the writeback stage 117 in order to determine if the instruction in the execute stage 111 reads a register that was written by the instruction in the memory access stage 115 or the writeback stage 117. If so, a result from the instruction in the memory access stage 115 or the writeback stage 117 is input to the ALU 113. The EX forward control unit 201B selects whether to use values read from the register file 109 or values forwarded from the memory access stage 115 or the writeback stage 117 by controlling fwda and fwdb signals. The fwda and fwdb signals are multiplexer selectors to the two forwarding multiplexers 203.

As pipelines in a forwarding pipeline grow deeper, many instructions obtain operands from the technique of forwarding and not having to read them from a register file. This ability to receive forwarded operands follows from a sequential property of most programs where instructions produce data that are used by directly following instructions. The typical prior art data forwarding scheme reads the register file for operands as part of every instruction decode cycle. This register read occurs without regard to whether data forwarding is either possible or not, or even if the forwarded data are needed. Therefore, what is needed is a way to enjoy benefits of forwarded operands while eliminating unnecessary register file reads and the concomitant increase in power caused by unnecessary register file reading.

### SUMMARY

An exemplary embodiment of the present invention includes a register file access method resulting in reduced power consumption. In accordance with the exemplary embodiment, if one or more registers to be read out of the register file is written by instructions located further downstream in a pipeline, the register file read of a forwardable register(s) is not initiated. Rather, the forwarded register value is used directly.

The present invention is therefore a system and method for preserving power in a microprocessor pipeline. The system includes a register file read control unit, the read control unit being configured to monitor one or more outputs from a control/decode unit of the pipeline and monitor write addresses from one or more other stages of the pipeline. The system also includes one or more read inhibit units each having an input, an output, and an enable terminal, the output of each of the one or more read inhibit units being coupled to a unique register port of a register file within the pipeline. The input of each of the one or more read inhibit units being coupled to the control/decode unit, and the enable terminal of each of the one or more read inhibit units being coupled to a unique output of the read control unit.

The method includes providing a read inhibit unit and a read control unit, the read inhibit unit being coupled to read a content of at least one file in a register file contained in the pipelined architecture. The read control unit provides a control signal to the read inhibit unit. A determination is made, based on the control signal, whether a register file read operation should occur. An enabling signal from the read control unit to the read inhibit unit is sent if a determination is made to read the content of the at least one file in the register file and, after receiving the enabling signal, reading the content of the at least one file in the register file.

### BRIEF DESCRIPTION OF THE DRAWINGS

FIG. 1 is a block diagram of a typical hardware-implemented pipeline of the prior art.

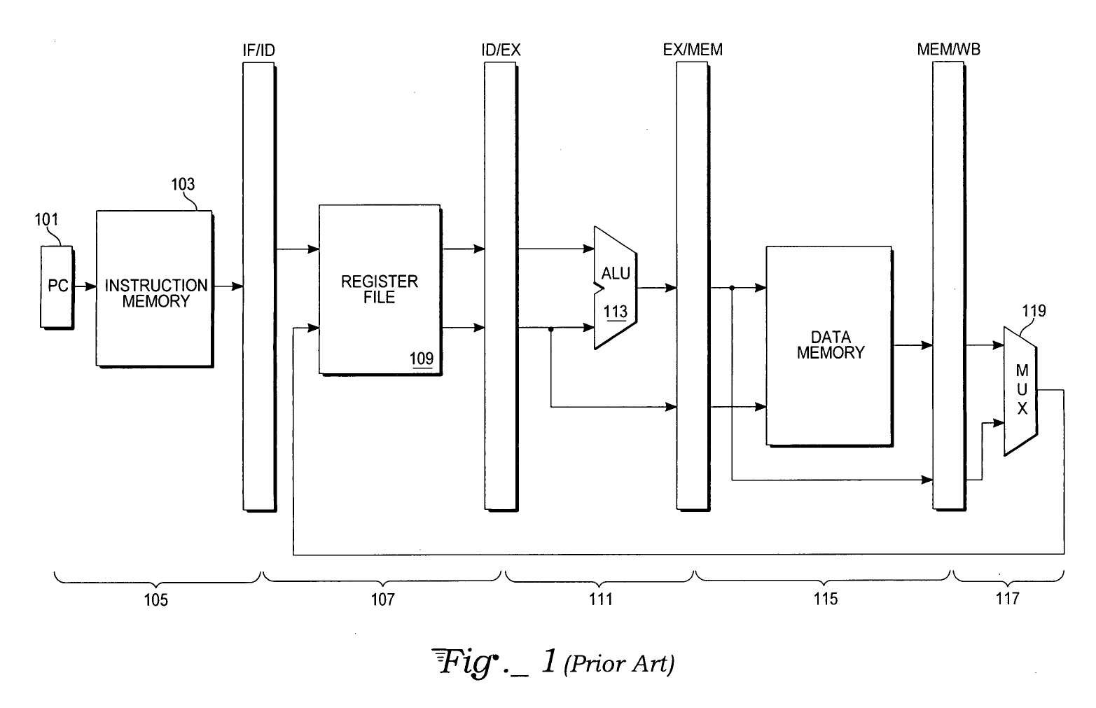

FIG. 2 is a block diagram of the hardware-implemented pipeline of the prior art incorporating a forwarding technique.

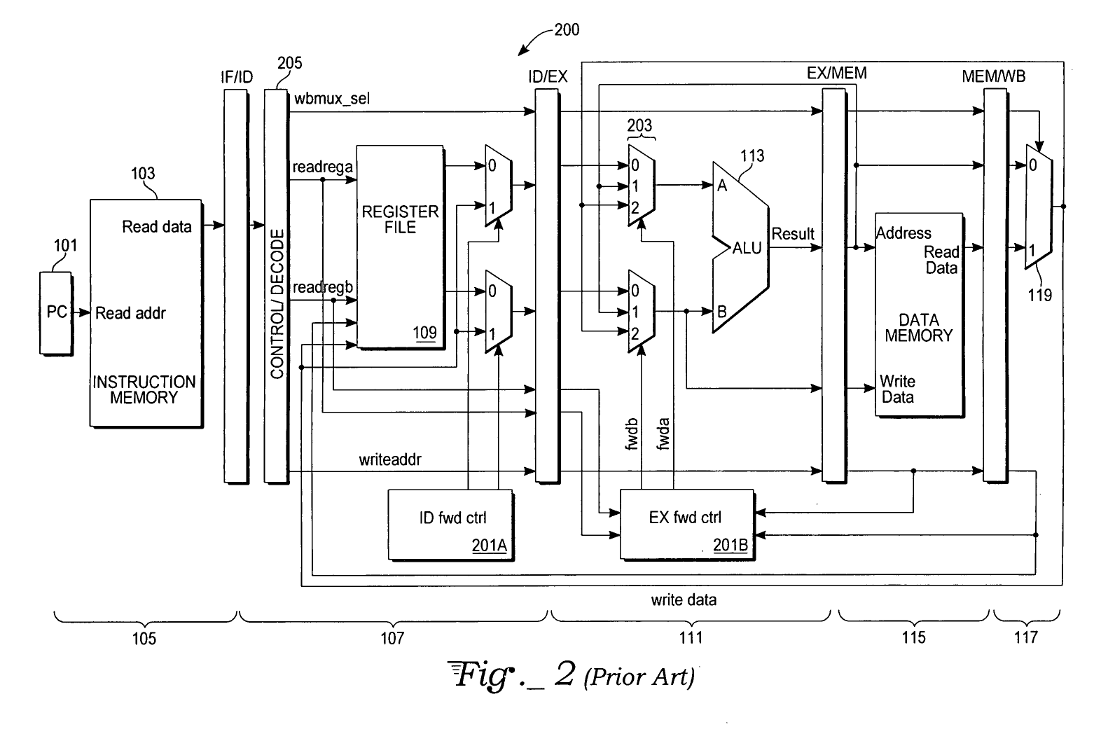

FIG. 3 is an exemplary block diagram of an embodiment of a pipeline incorporating a forwarding technique not requiring access of a register file each clock cycle.

FIG. 4 is an exemplary embodiment of a type of state-keeping device for accessing a register file.

### DETAILED DESCRIPTION

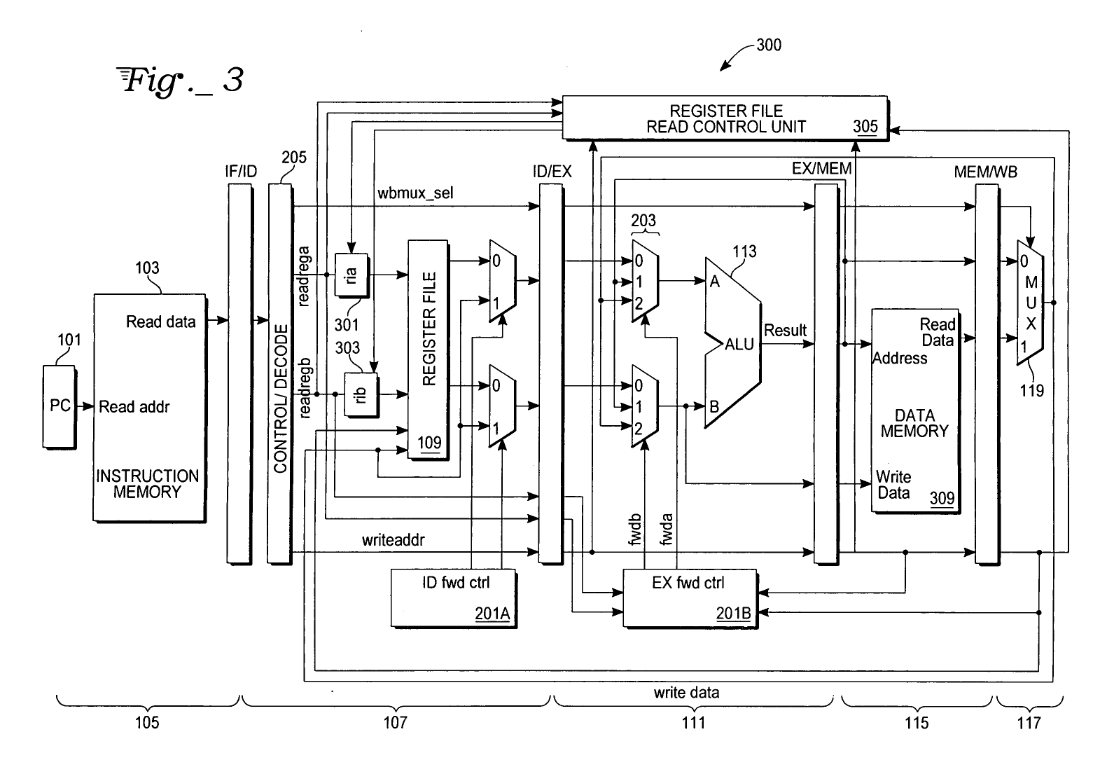

An exemplary embodiment of a pipeline 300 not requiring access of a register file each clock cycle of FIG. 3 implements a register file read control unit (RCU) 305 and two register file inhibit units, read inhibit unit A (ria) 301 and read inhibit unit B (rib) 303. The RCU 305 continuously monitors readrega and readregb outputs from the control/decode unit 205. The RCU 305 also monitors write addresses the execute stage 111, the memory access stage 115, and the writeback stage 117. If the readrega or readregb signals that a register written by the execute stage 111, the memory access stage 115 or the writeback stage 117 is to be read by an instruction in the instruction decode and register file read stage 107, the RCU 305 orders the corresponding register file read inhibit unit (ria 301 or rib 303) to not read the register file 109, as the result will be forwarded. The register file read inhibit units (ria 301 and rib 303) prevent the register file 109 from reading the register addressed by readrega and/or readregb. The read inhibit units ria 301, rib 303 do this in a way so that the register file read port does not draw any power (described infra).

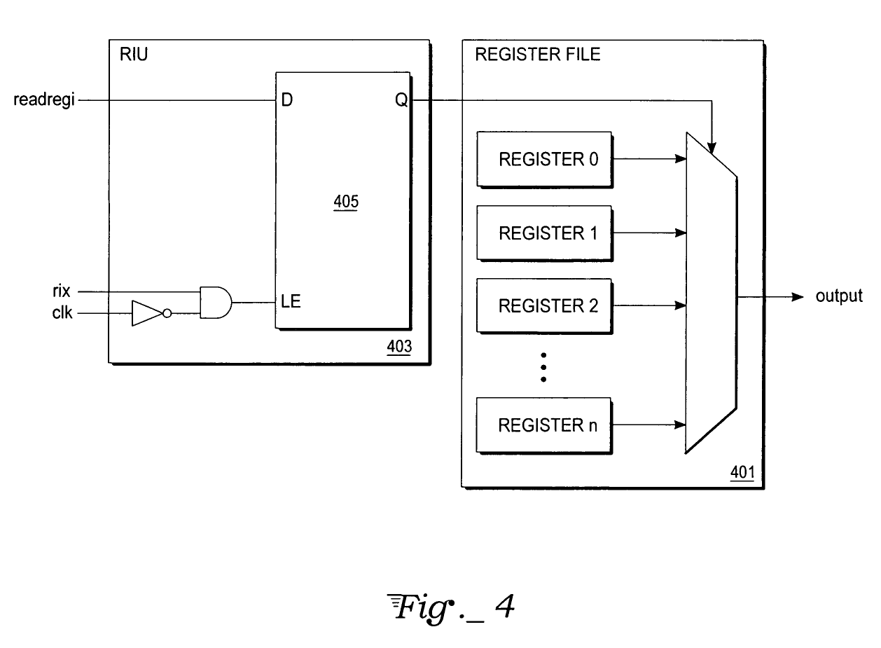

Most modern central processing units (CPUs) are implemented using CMOS logic. Most of the power dissipated in CMOS logic is drawn when a CMOS logic value toggles (i.e., from “1” to “0” or “0” to “1”). One primary function of the read inhibit units ria 301, rib 303 is therefore to prevent logic inside the register file 109 from toggling if no read access is needed, thereby causing the register file 109 to draw a minimal amount of power. To prevent internal logic (not shown) of the register file 109 from toggling, the read inhibit units ria 301, rib 303 include a state-keeping element (discussed in more detail with respect to FIG. 4, infra). The state-keeping element may be, for example, a level-sensitive latch or a flip-flop. The state-keeping element is connected to all register file read port inputs thereby preventing the register file read port inputs from toggling if a read port access is not needed due to forwarding. The state-keeping element is controlled by the RCU 305.

The read inhibit units ria 301, rib 303 may be implemented in one of several ways, dependent, in part, on how the register file 109 is implemented. In some register file implementations, the state-keeping element is built into a register file macro. In the case of such a register file macro, the RCU 305 may control the state-keeping element in the register file macro directly and no additional read inhibit units ria 301, rib 303 are needed.

FIG. 4 illustrates an exemplary embodiment of a type of state-keeping element accessing a register file 401. The register file 401 has a plurality of registers (i.e., Register 1, Register 2, . . . , Register n). Each of the registers has a data width of “m” bits. An output of the register file 401 combinatorically outputs a content of an addressed register within the register file 401. For example, an input address “readregi” would read a data content of the i^{th} register. A state-keeping element in a read inhibit unit (RIU) 403 is comprised of a level-sensitive latch 405. The level-sensitive latch 405 is transparent when a latch-enable (LE) input is high. LE is controlled by an expression:
rix && !clk
   The “rix” signal is output from the RCU 305 (FIG. 3) and is “high” if the register to be read by an instruction in the instruction decode and register file read stage 107 (FIG. 3) is forwardable from another pipeline stage. In order to keep the “Q” output of the level-sensitive latch 405 from toggling until the “rix” signal has stabilized, “rix” is logically ANDed with the inverted clock. A half-clock cycle is added if all other sequential elements are clocked by a positive edge trigger, thus allowing time for “rix” to stabilize. An expression for implementing “rix” may be:
rix=(readregi==id_ex_wadr) ∥
(readregi==ex_mem_wadr) ∥
(readregi==mem_wb_wadr)
   where i ε {a, b}, and id_ex_wadr, ex_mem_wadr, and mem_wb_adr are addresses of the register file register to be written by an instruction in the execute stage 111, the memory access stage 115, and the writeback stage 117, respectively.

A skilled artisan will recognize that other delays, both larger and smaller, may be used by substituting “clk” by adding one or more delay elements with different propagation delay times. Consequently, the read address “readregi” propagates to the register file 401 port only if “rix” is high and in the last half period of the clock cycle. If “rix” is low, the level-sensitive latch 405 is locked (i.e., not enabled) and inputs to the register file 401 are kept static. The register file 405 read port does not toggle in this case; thus, minimal power is consumed. In a specific exemplary embodiment, there is one RIU 403 per register file read port. The register file of FIG. 3 has two read ports. Thus, there are two RIUs, read inhibit units ria 301, rib 303.

In another exemplary embodiment (not shown), a latch is built into the register file read port. In these cases, no latch is required in the RIU 403. The RCU 305 will then control the latch 405 inside the register file 401 read port directly.

In the foregoing specification, the present invention has been described with reference to specific embodiments thereof. It will, however, be evident to a skilled artisan that various modifications and changes can be made without departing from the broader spirit and scope of the invention as set forth in the appended claims. Skilled artisans will appreciate that although the methods have been presented with reference to a specific architecture, a similar result may be achieved in various ways that are still within a scope of the described specification. For example, a skilled artisan will recognize other embodiments (not shown) in which it may be desirable to use an edge-triggered flip-flop rather than a level-sensitive latch. The RCU 305, described supra, may still be used with appropriate connections and delays. Due to the complexity of an actual microprocessor pipeline, the specification and drawings are, accordingly, to be regarded in an illustrative rather than a restrictive sense.

What is claimed is:

1. A power saving electronic device in a microprocessor pipeline, the device comprising:
a register file read control unit, the read control unit being configured to monitor one or more outputs from a control/decode unit of the pipeline, the read control unit being further configured to monitor write addresses from one or more other stages of the pipeline; and
one or more read inhibit units, the one or more read inhibit units each having an input, an output, and an enable terminal, the output of each of the one or more read inhibit units being coupled to a unique register port of a register file within the pipeline, the input of each of the one or more read inhibit units being coupled to the control/decode unit, and the enable terminal of each of the one or more read inhibit units being coupled to a unique output of the read control unit.

2. The device of claim 1 wherein the read control unit is further configured to send a signal to the one or more read inhibit units to prevent an instruction in the instruction decode and register file read stage from reading the register file if a result will be forwarded.

3. The device of claim 1 wherein each of the one or more read inhibit units is comprised of a level-triggered latch.

4. The device of claim 3 wherein each of the one or more read inhibit units is further comprised of combinatorial logic, the combinatorial logic being configured to allow a read of the register file only when a read signal is sent from the read control unit.

5. The device of claim 1 wherein each of the one or more read inhibit units is comprised of an edge-triggered latch.

6. The device of claim 5 wherein each of the one or more read inhibit units is further comprised of combinatorial logic, the combinatorial logic being configured to allow a read of the register file only when a read signal is sent from the read control unit.

7. The device of claim 1 wherein each of the one or more read inhibit units is integral to the register file.

8. A power saving electronic device in a microprocessor pipeline, the device comprising:
a register file read control unit, the read control unit being configured to monitor one or more outputs from a control/decode unit of the pipeline, the read control unit being further configured to monitor write addresses from one or more other stages of the pipeline;
one or more read inhibit units, the one or more read inhibit units each having an input, an output and an enable terminal, the output of each of the one or more read inhibit units being coupled to a unique register port of a register file within the pipeline, the input of each of the one or more read inhibit units being coupled to the control/decode unit, and the enable terminal of each of the one or more read inhibit units being coupled to a unique output of the read control unit; and
one or more forward control units, each of the one or more forward control units being coupled to a unique stage of the pipeline and configured to provide intermediate results to each of the unique stages of the pipeline, at least one of the one or more forward control units being coupled to a writeback stage of the pipeline.

9. The device of claim 8 wherein the read control unit is further configured to send a signal to the one or more read inhibit units to prevent an instruction in the instruction decode and register file read stage from reading the register file if a result will be forwarded.

10. The device of claim 8 wherein each of the one or more read inhibit units is comprised of a level-triggered latch.

11. The device of claim 10 wherein each of the one or more read inhibit units is further comprised of combinatorial logic, the combinatorial logic being configured to allow a read of the register file only when a read signal is sent from the read control unit.

12. The device of claim 8 wherein each of the one or more read inhibit units is comprised of an edge-triggered latch.

13. The device of claim 12 wherein each of the one or more read inhibit units is further comprised of combinatorial logic, the combinatorial logic being configured to allow a read of the register file only when a read signal is sent from the read control unit.

14. The device of claim 8 wherein a first of the one or more forward control units is electrically coupled to select an output of a plurality of multiplexers in an execute stage of the pipeline, an output of each of the plurality of multiplexers being coupled to an input of an arithmetic logic unit.

15. The device of claim 8 wherein each of the one or more read inhibit units is integral to the register file.

16. A method for preserving power in a microprocessor pipelined architecture, the method comprising:
providing a read inhibit unit, the read inhibit unit being coupled to read a content of at least one file in a register file contained in the pipelined architecture,
providing a register file read control unit, the read control unit providing a control signal to the read inhibit unit;
determining, based on the control signal, whether a register file read operation should occur;
providing an enabling signal from the read control unit to the read inhibit unit if a determination is made to read the content of the at least one file in the register file; and
reading the content of the at least one file in the register file.

17. The method of claim 16 further comprising providing a read address of the register file once the read inhibit unit receives the enable signal from the read control unit.

18. A power saving electronic device in a microprocessor pipeline, the device comprising:
a register file read control means for monitoring one or more outputs from a control/decode unit of the pipeline and monitoring write addresses from one or more other stages of the pipeline; and
a read inhibit means for allowing a read of a register file in the pipeline based on receiving a read enable signal from the register file read control means.

19. The device of claim 18 further comprising:
a forwarding multiplexer, the forwarding multiplexer having a first input, a second input, and a multiplexer output, the first input being coupled to an output of the register file, the second input being coupled to an output from a writeback stage of the pipeline, the multiplexer output being coupled to an input of an arithmetic logic unit within the pipeline; and
a forward control means for providing intermediate results to one or more unique stages of the pipeline.

20. The device of claim 19 wherein the forward control means provides a signal from a writeback stage of the pipeline.

21. The device of claim 18 further comprising a read address means for providing a read address of the register file once the read inhibit means receives an enable signal from the read control means.
